(19) United States
(12) Patent Application Publication
(10) Pub. No.: US 2013/0060649 A1
(43) Pub. Date: Mar. 7, 2013

(54) Selecting Products for Retailer to Offer for Sale to Consumers

(71) Applicants: Julie Ward Drew, Redwood City, CA (US); Filippo Balestrieri, Mountain View, CA (US); Enis Kayis, East Palo Alto, CA (US); Shyam Sundar Rajaram, Mountain View, CA (US); Shailendra K. Jain, Sunnyvale, CA (US)

(72) Inventors: Julie Ward Drew, Redwood City, CA (US); Filippo Balestrieri, Mountain View, CA (US); Enis Kayis, East Palo Alto, CA (US); Shyam Sundar Rajaram, Mountain View, CA (US); Shailendra K. Jain, Sunnyvale, CA (US)

(73) Assignee: Hewlett-Packard Development Company, L.P., Houston, TX (US)

(21) Appl. No.: 13/634,772

(22) PCT Filed: Apr. 19, 2010
(86) PCT No.: PCT/US2010/003168

§ 371 Date: Sep. 13, 2012

(51) Int. Cl. G06Q 30/00

(52) U.S. Cl. 705/26.1

(57) ABSTRACT

Each product of a number of products is assigned to one of a number of popularity tiers. The popularity tiers are ordered from a most popular tier to a least popular tier. The popularity tiers indicate how popular the products are expected to be among consumers. Each product is assigned to one of a number of margin tiers. The margin tiers are ordered from a highest margin tier to a lowest margin tier. The margin tiers indicate how much money a retailer makes in selling the products to the consumers. Which of the products to offer for sale by the retailer to the consumers are selected by applying decision rules to the products as have been assigned to the popularity tiers and to the margin tiers.

### BACKGROUND

Consumers typically purchase products from retailers. The consumers may be people or businesses. The retailers may be “bricks-and-mortar” retailers that maintain physical stores from which products can be purchased, and/or the retailers may be online retailers that maintain Internet web sites and/or other virtual points of presence from which products can be purchased. The products may be physical products, intangible products like software, music, movies, and television shows, as well as subscriptions, services, rentals, leases, and other types of items that can be purchased.

### BRIEF DESCRIPTION OF THE DRAWINGS

FIG. 1 is a flowchart of a method, according to an embodiment of the present disclosure.

FIGS. 2A and 2B are flowcharts of a method for assigning products to popularity tiers, according to an embodiment of the present disclosure.

FIG. 3 is a flowchart of a method for assigning products to margin tiers, according to an embodiment of the present disclosure.

FIG. 4 is a diagram of a representative decision rule that can be used to select which products to offer for sale and to rank the products that are offered for sale, according to an embodiment of the present disclosure.

FIG. 5 is a flowchart for selecting which products to offer for sale by applying decision rules to the products as they have been assigned to popularity tiers and margin tiers, according to an embodiment of the present disclosure.

FIG. 6 is a diagram of a system, according to an embodiment of the present disclosure.

### DETAILED DESCRIPTION

As noted in the background section, consumers typically purchase products from retailers. A retailer generally has a limited number of product slots that can be filled with products to offer for sale to consumers. For example, for a physical store, there is a limited amount of shelf space that can be populated with products. As another example, for an online store, there is a limited amount of screen space on a web page that can be populated with products without, for instance, forcing the user to scroll down. That is, when a user browses to a web page using his or her computing device, generally just a portion of the web page on which products can be displayed can be seen by the user at one time.

Therefore, retailers are forced to consider how to select which products to offer for sale to consumers in this limited number of slots. This problem is exacerbated for a retailer that does not have preexisting sales data as to the products that the retailer sold to consumers in the past. For example, the retailer may be just starting its business, such that there is no such preexisting sales data. As other examples, the retailer may be entering a new market, or the retailer may be beginning to sell products that it has not sold before. A market may be a geographical market, such as the United States, Europe, or Japan. As a final example, the products in question may be new, and may not have been available before for selling to consumers.

Embodiments of the disclosure permit a retailer to select which products to offer for sale to consumers, such as where there are a limited number of slots that can be populated with products. In general, the slots are filled with products that are popular among consumers and that offer the retailer the highest margins. Where no preexisting sales data pertaining to the retailer itself is available for a given product or market, other preexisting sales data pertaining to other retailers, other markets, and/or other products may be employed. Other types of data, such as that indicating how long ago a product was released, the manufacturer of the product, and so on, can also be used.

Each product is assigned to a popularity tier that indicates how popular the products are among consumers, such as based on preexisting sales data and other types of data. Each product is also assigned to a margin tier that indicates how much money a retailer makes in selling the product to consumers. Decision rules are then applied to the products, on the basis of the popularity tiers and the margin tiers to which they have been assigned, to select the products that the retailer is to offer for sale to consumers, such as in the limited number of available slots that can be populated or filled with products.

Using the popularity tiers and the margin tiers to which the products have been assigned when applying the decision rules is particularly advantageous, because it avoids “information overload” by the retailer in selecting which products to offer for sale to consumers. For example, there may be hundreds of products, but just tens of slots that are to be filled with products for the retailer to actually offer for sale to consumers. The products that are in both the highest popularity tier and the highest margin tier may be selected for populating the slots, whereas products that are in both the lowest popularity tier and the lowest margin tier may not be selected for populating the slots.

If empty slots still remain after the products belonging to both the highest popularity tier and the highest margin tier have been selected, then the decision rules may advance to products that either are in the highest popularity tier but not the highest margin tier, or are in the highest margin tier but not the highest popularity tier. If there are more such products than the number of remaining empty slots, the retailer may be permitted to select which of these products should fill the remaining empty slots. In this way, the retailer does not experience information overload.

Particularly, the retailer does not have to select the products belonging to both the highest popularity tier and the highest margin tier, because these products are automatically selected. Likewise, the products belonging to both the lowest popularity tier and the lowest margin tier are automatically not selected, without user interaction. The retailer is instead presented with a shortened list of products from which to fill the remaining empty slots, specifically (in this example) those that are in the highest popularity tier but not the highest margin tier, and those that are in the highest margin tier but not the highest popularity tier. The number of such products may be significantly lower than the total number of products, providing the retailer with better focus when selecting which products should fill the remaining empty slots.

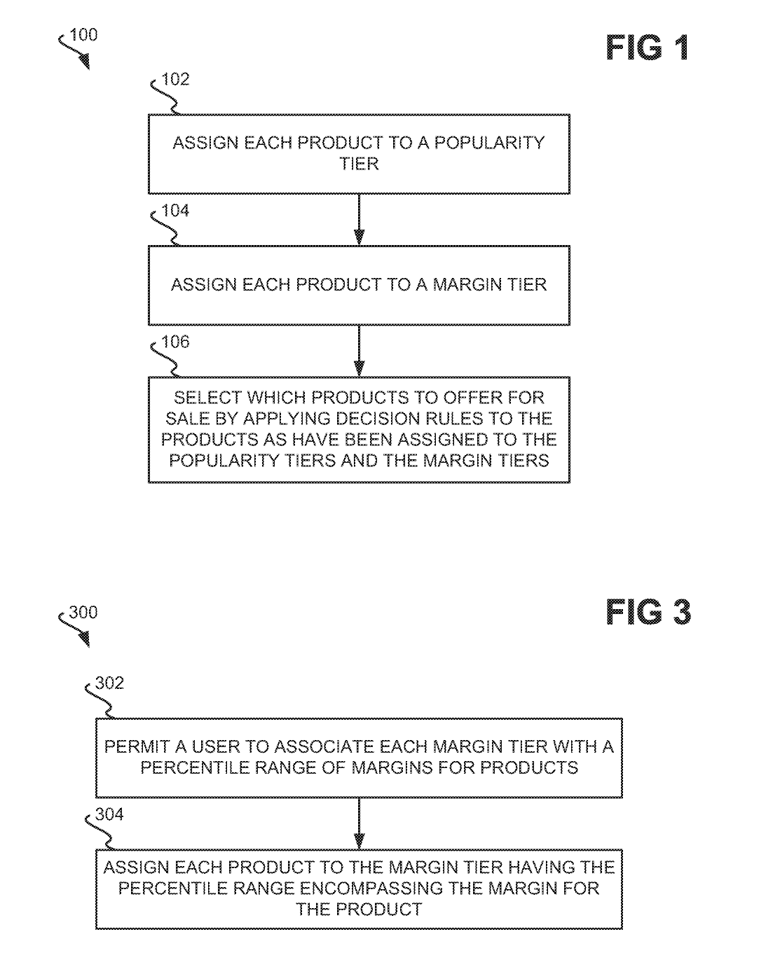

FIG. 1 shows a method 100, according to an embodiment of the disclosure. As with other methods of embodiments of the disclosure, the method 100 can be performed by a computing device. For instance, a tangible computer-readable data storage medium may store one or more computer programs, which when executed by the computing device cause the method 100 to be performed.

The method 100 assigns each product of a number of products to one of a number of different popularity tiers (102). The popularity tiers are ordered from a most popular tier to a least popular tier. The popularity tiers indicate how popular the products are expected to be among consumers. In one embodiment, there are three popularity tiers: a most popular tier, a least popular tier, and a tier between the most popular tier and the least popular tier. As such, products assigned to the most popular tier are expected to be the most popular products among consumers, whereas products assigned to the least popular tier are expected to be the least popular products among consumers. One embodiment of assigning products to popularity tiers is described in detail later in the detailed description.

The method 100 also assigns each product to one of a number of different margin tiers (104). The margin tiers are ordered from a highest margin tier to a lowest margin tier. The margin tiers indicate how much money a retailer makes in selling the products to the consumers, such as on an absolute-dollar basis, or on a percentage of selling price basis. In one embodiment, there are three margin tiers: a highest margin tier, a least margin tier, and a tier between the highest margin tier and the lowest margin tier. As such, products assigned to the highest margin tier are the products on which the retailer makes the most money when selling the products to consumers, whereas products assigned to the lowest margin tier are the products on which the retailer makes the least money when selling the products to consumers. One embodiment of assigning products to margin tiers is described later in the detailed description.

The method 100 then selects which of the products to offer for sale (106), such as by filling each of a number of predetermined empty product slots with one of the products. Part 106 is performed by applying decision rules to the products, based on the popularity tiers and the margin tiers to which the products have been assigned. One embodiment of selecting which products to offer for sale by applying decision rules to the products as have been assigned to the popularity tiers and the margin tiers is described in detail later in the detailed description.

A product as this term is used herein may in actuality encompass multiple complementary products that are sold together as a bundle. For example, a product may be a certain word processing program that has a complementary book providing information on how to use the program. In this case, both the word processing program and the book are together considered a single product when they are sold together as a bundle. The popularity, margin, and so on, are considered as to the product bundle as a whole. However, another product may be just the word processing program itself—i.e., without the book—or just the book itself—i.e., with the word processing program itself. That is, a product bundle is considered as its own product herein, and the constituent products of such a bundle may themselves also be considered as products herein.

In one embodiment, as part of selecting which of the products to offer for sale in part 106, the products that are offered for sale are implicitly or explicitly ranked as well. For example, there may be various tiers of products that are offered for sale. Products in a higher tier may be given more visibility when offered for sale as compared to products in a lower tier. For instance, on an Internet web page offering the products for sale, the products in the higher tier may receive more space on the web page to advertise them as compared to products in the lower tier.

In one embodiment, it is presumed that the products that are selected have sufficient inventory levels for the retailer to sell them. Stated another way, in this embodiment, the inventory levels of the products are not considered in this embodiment when selecting which products to offer for sale. Rather, there is assumed to be a sufficient inventory of each product that is offered for sale.

A retailer may in some case decide to offer products for sale because the retailer holds too much inventory of them, and/or because the retailer wants to free up warehouse or other space so that inventories of other products can be maintained. Because embodiments of the disclosure are concerned with selecting which products to offer from sale from a larger number of products, the retailer may thus select which products to offer from sale just from those products for which the retailer has too much inventory and/or from those products of which the retailer wants to decrease inventory. Stated another way, at least some embodiments are not concerned with inventories, in terms of how the products to offer for sale are selected from a larger number of products, although from which products the products to offer for sale are selected may be decided by the retailer in any given manner.

More generally, such embodiments of the disclosure are not concerned with inventories as to how the products to offer for sale are selected, such that these embodiments are not concerned that the retailer cannot keep inventories of given products, that inventories of the product cannot be physically stored per se, that the retailer's inventory capabilities are virtually infinite, and so on. However, embodiments of the disclosure may be employed within a larger process that does take into account inventories. In this respect, the output of the method 100 may be used as input to such a larger process.

It is noted that the method 100 is applicable to products within the same category as well as to products within different categories. For example, as to products within the same category, all such products may be video games. As another example, as to products within different categories, some products may be educational software, whereas other products may be productivity software. In this latter example, the method 100 implicitly takes into account the tradeoffs that may have to be made when selecting products across different categories, in terms of product popularity, product margin, and so on.

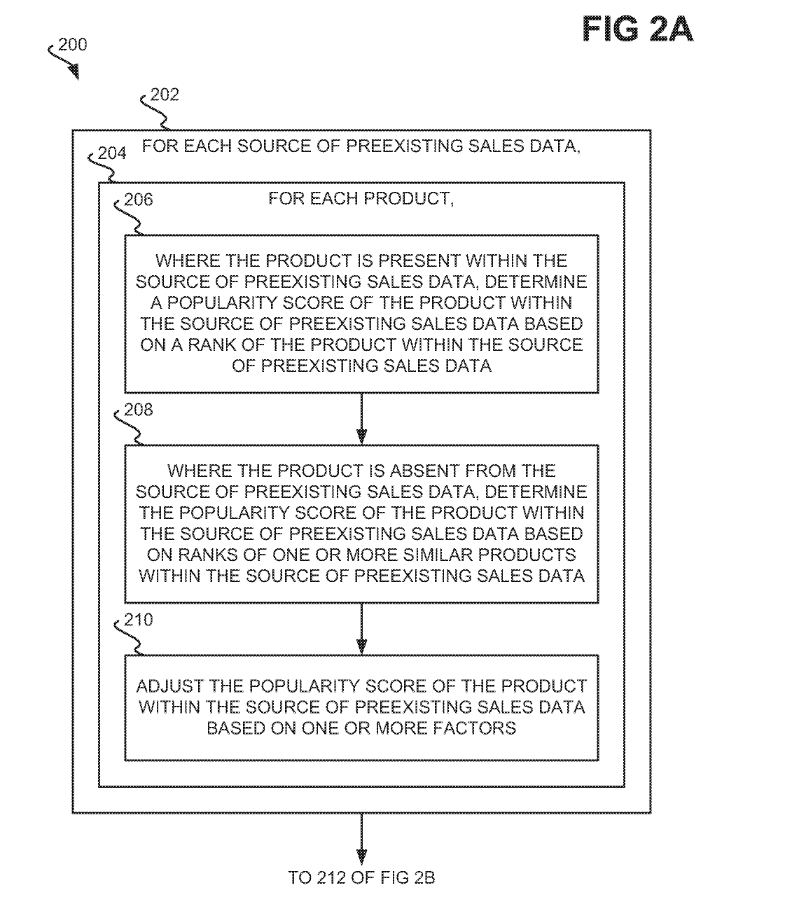

FIGS. 2A and 2B show a method 200 for assigning products to popularity tiers, according to an embodiment of the disclosure. The method 200 can be used to implement part 102 of the method 100 of FIG. 1. The method 200 generally assigns products to popularity tiers using preexisting sales data, data regarding how long ago the products have been released for sale to consumers, as well as other data, such as the manufacturer of the products, sales of related products, and so on.

In some situations, there may be no preexisting sales data for a given retailer in relation to the products to be offered for sale in a given market. In these and other cases, other types of preexisting sales data can be used. For instance, preexisting sales data may be available that indicates for a given market a popularity ranking of products, in order of the number of products sold. For example, with respect to books, preexisting sales data may be available that indicates the most sold book, followed by the next-most sold book, and so on, for the top one-hundred selling books for a given period of time in a given market, like the United States. Such data may be available for a number of different markets, or may be available for the same market by a number of different data providers. Each set of preexisting sales data is referred to as a source of preexisting sales data.

For each source of preexisting sales data (202), and for each product (204), the following is performed. If the product is present within the source of preexisting sales data, a popularity score of the product within this source of preexisting sales data is determined, based on the rank of the product within the source (206). For example, a popularity score may be between zero and one, where zero indicates least popular and one indicates most popular. If a source of preexisting sales data lists 500 products, and a product is ranked 35th among these 500 products, then the product's popularity score for this source of preexisting sales data can be determined as

$$\frac{500 - 35}{500} = 0.93 .$$

Alternatively, a product may be absent from a source of preexisting sales data. In this case, the popularity score of the product within this source of preexisting sales data would normally be set to zero. However, in one embodiment, where the product is absent from a source of preexisting sales data, the popularity score of the product within this source of preexisting sales data is determined based on the ranks of one or more similar products within the source of preexisting sales data (208).

For instance, a product may be a particular configuration for a given model of laptop computer. If this product is absent from a source of preexisting sales data, but a product having a similar configuration for the same model of laptop computer is present, then the latter product's rank within the source of preexisting sales data may be used to determine the popularity score for the absent model. For example, the product in question may be a given model of laptop computer having a certain sized hard drive, a certain amount of memory, and a processor rated at a certain speed. If this product is absent from a source of preexisting sales data, but a product that is the same model of laptop computer having the identically sized hard drive, an identical amount of memory, but a processor that is rated at a slightly lower or slightly faster speed, then the latter product may be used to determine the former product's popularity score as to the source of preexisting sales data in question.

As another example, if a product is absent from a source of preexisting sales data, but a category of similar products are present within the source of preexisting sales data, the popularity scores for the similar products may be averaged to determine the popularity score for the absent product. For instance, a product may as before be a particular configuration for a given model of laptop computer. If this product is absent from a source of preexisting sales data, but products having other configurations for the same model of laptop computer are present, then the latter products' popularity scores may be determined and averaged to determine the popularity score for the absent product.

As a third example, a product such as a video game may not yet have been offered for sale, such that there is no preexisting sales data of the video for the product in any source. However, the product may be based on a movie. Therefore, the popularity of the movie may be used as a way to gauge the popularity of the video game.

In one embodiment, the popularity score of a product within a source of preexisting sales data may be adjusted based on one or more factors (210). One such factor is the price that the retailer is planning to charge for the product in comparison to the price of the product as reflected in the preexisting sales data. For example, if the retailer will be selling the product for a significantly higher price, than the popularity score of the product may be decreased to compensate for an expected lower popularity within the retailer's store. Similarly, if the retailer will be selling the product for a significantly lower price, then the popularity score of the product may be increased to compensate for an expected higher popularity within the retailer's store.

Another factor is the seasonality, of the product in question. For example, certain products are likely to be more popular at certain times of year, such as the Christmas holiday shopping season and the back-to-school shopping season, than other products. Examples of such products include computers, which are more likely to be purchased during the Christmas holiday shopping season and the back-to-school shopping season. Other examples of such products include high-definition televisions, which are more likely to be purchased during the Christmas holiday shopping season and during the weeks before the Super Bowl that culminates the professional football season. In such cases, the popularity score for such products may be increased or decreased accordingly.

Another example of seasonality is when a product is linked to another product. For example, a video game may be based on a movie. The “season” for the video game may be considered as including the first few weeks or months following the release of the movie. That is, the period of time when the movie is most popular is when the video game is likely to be most popular.

A third factor includes the present economic conditions of the market in which the retailer will be selling a product. For example, in times of recession, consumers are less likely to purchase big-ticket items such as kitchen appliances. In these cases, too, the popularity, score for such products may be increased or decreased accordingly. Parts 206, 208, and/or 210 are thus repeated for each product, and for each source of preexisting sales data that is available and desired to be used.

Furthermore, in one embodiment, the degree to which a given product that is absent from a source of preexisting sales data can be substituted by one or more products that are present within a source of preexisting sales data may be a factor used to adjust the popularity score that has been assigned to the given product. For example; if the products that have had their popularity scores substituted for the popularity score of the given product are very similar to the given product, then the popularity score of the given product may be not adjusted at all. However, if the products that have had their popularity scores substituted for the popularity score of the given product are more dissimilar to the given product, then the popularity score of the given product may be adjusted downwards. This downwards adjustment thus can reflect the lower confidence level as to the accuracy of the popularity score of the given product.

Next, for each product, another popularity score can be determined based on how long ago the product was released for purchase by consumers (212). For certain types of products, such as mobile phones, a product may sell the best and be most popular in the first few months after the product is released. Thereafter, sales of the product may slowly decrease before they plateau to a stable level, for instance.

In one embodiment, this popularity score is determined as being zero for products that have been released more than twelve months ago. For other products, the popularity score is determined as

$$\frac{12 - M}{12} ,$$

where M is the number of months a given product has been available for purchase (i.e., the number of months since release). Therefore, for a product that was released four months ago, this popularity score is determined as

$$\frac{12 - 4}{12} = 0.67 .$$

It is noted that other popularity scores may also be determined, based on other sources of data. As one example, in addition to popularity scores based on preexisting sales data sources, another popularity score may be determined based on rankings of products among professional and/or end-user reviewers. Products have better reviews than other products thus receive higher corresponding popularity scores than these other products.

A user is permitted to assign weights to the popularity scores, by preexisting sales data source, and by how long ago the given product was released for purchase by consumers (214). Stated another way, a given preexisting sales data source is assigned a weight, such that the popularity scores of products for this given preexisting sales data source all have this weight. Similarly, how long ago products were released for purchase by consumers is also assigned a weight, such that the popularity scores of products based on how along ago they were released all have this weight.

For example, there may be two sources of preexisting sales data. The first source may be assigned a weight of 0.4, whereas the second source may be assigned a weight of 0.3. Finally, how long ago the given products were released for purchase by consumers may also be assigned a weight of 0.3.

Thereafter, an overall popularity score is determined for each product, as the sum of each popularity score times the weight of the popularity score (216). In mathematical terms, the overall popularity score for a product is

$${P}_{i} = {\sum }_{j = 1}^{n} {p}_{ij} {w}_{j} .$$

In this equation, Pᵢ is the overall popularity score for product and there are differently determined popularity scores Pᵢⱼ for product i, and corresponding weights wⱼ.

Using the previous example, then, a given product may have a popularity score of 0.80 for the first source of preexisting sales data, and a popularity score of 0.90 for the second source of preexisting sales data. The product may also have a popularity score of 0.70 for how long ago the given product was released for purchase by consumers. Therefore, the overall popularity score for the product is (0.80×0.4)+(0.90×0.3)+(0.70×0.3)=0.80.

It is noted that in one embodiment, the weights can be selected so that their sum is equal to one. In the example, for instance, the weights 0.4+0.3+0.3=1.0. Having the sum of the weights equal to one can ensure that a user is explicitly aware that by increasing one weight, the effect of at least one of the other weights is decreased, and vice-versa. For example, for the three weights 0.4, 0.3, and 0.3, if the first weight is increased to 0.5 and neither of the other two weights is decreased, the user may not be aware that the effects of the other weights are in actuality decreased. However, if the first weight is increased to 0.5 and the sum of the weights has to remain equal to one, then the user will have to decrease the second and/or third weights, such that the user becomes explicitly aware that the effects of the second and/or third weights have been decreased.

The user is permitted to associate each popularity tier with a percentile range of the overall popularity scores for the products (218). For example, in the case where there are three popularity tiers, the most popular tier may be associated with products having overall popularity scores that place them above the 80th percentile of all products by overall popularity score. The middle tier may be associated with products having overall popularity scores that place them between the 20th percentile and the 80th percentile of all products by overall popularity score. The least popular tier may be associated with products having overall popularity scores that place them below the 20th percentile of all products by overall popularity score. In one embodiment, the number of percentile ranges with the popularity tiers are associated may be related to the number of slots that are to be populated with products. For example, the greater the number of slots there are, the greater the number of percentile ranges there may be with which to associate the popularity tiers.

Each product is then assigned to the popularity tier having the percentile range encompassing the overall popularity score for the product in question (220). Using the previous example, if a product is in the top 20th percentile by overall popularity score, it is assigned to the most popular tier. If a product is in the middle 60th percentile by overall popularity score, it is assigned to the middle tier. If a product is in the bottom 20th percentile by overall popularity score, it is assigned to the least popular tier.

It is noted that in this example, the overall popularity score for a product does not by itself dictate the popularity tier to which the product is assigned. Rather, the percentile of the overall popularity score for the product as compared to all the products' overall popularity scores dictates to which popularity tier the product is assigned. As an extreme example, a product may have an overall popularity score of 0.90, but if eighty percent of the other products have overall popularity scores greater than 0.90, then the product will be located in the bottom 20th percentile by overall popularity score, and hence assigned to the least popular tier.

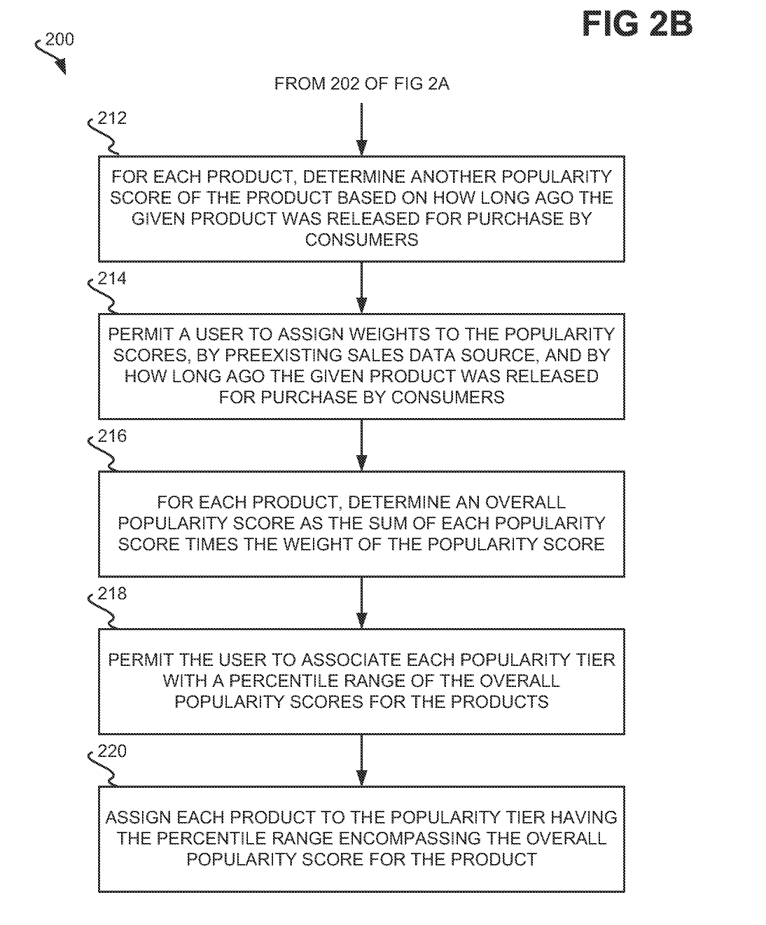

FIG. 3 shows a method 300 for assigning products to margin tiers, according to an embodiment of the disclosure. The method 300 can be used to implement part 104 of the method 100 of FIG. 1. The method 300 generally assigns products to margin tiers based on the margins for the products. The margins may be expressed in absolute dollar terms, or as a percentage of sales price.

A user is permitted to associate each margin tier with a percentile range of the margins for the products (302). For example, in the case where there are three margin tiers, the highest margin tier may be associated with products having margins that place them above the 80th percentile of all products by margin. The middle tier may be associated with products having margins that place them between the 20th percentile and the 80th percentile of all products by margin. The lowest margin tier may be associated with products having margins that place them below the 20th percentile of all products by margin.

Each product is then assigned to the margin tier having the percentile range encompassing the margin for the product in question (304). Using the previous example, if a product is in the top 20th percentile by margin, it is assigned to the highest margin tier. If a product is in the middle 60th percentile by margin, it is assigned to the middle tier. If a product is in the bottom 20th percentile by margin, it is assigned to the lowest margin tier.

It is noted that in this example, the margin for a product does not by itself dictate the margin tier to which the product is assigned. Rather, the percentile of the margin for the product as compared to all the products' margins dictates to which margin tier the product is assigned. As an extreme example, a product may have a margin of 90%, meaning that 90% of the sales price for the product is profit. However, if eighty percent of the other products have margins greater than 90%, then the product will be located in the bottom 20th percentile by margin, and hence assigned to the lowest margin tier.

Once the products have been assigned to popularity tiers, such as via the method 200 of FIG. 2, and have been assigned to margin tiers, such as via the method 300 of FIG. 3, which products are to be offered for sale to consumers by the retailer are selected. That is, for a limited number of product slots, products are selected to fill these product slots. As has been noted above, this selection process is achieved by applying decision rules to the products as have been assigned to popularity tiers and margin tiers.

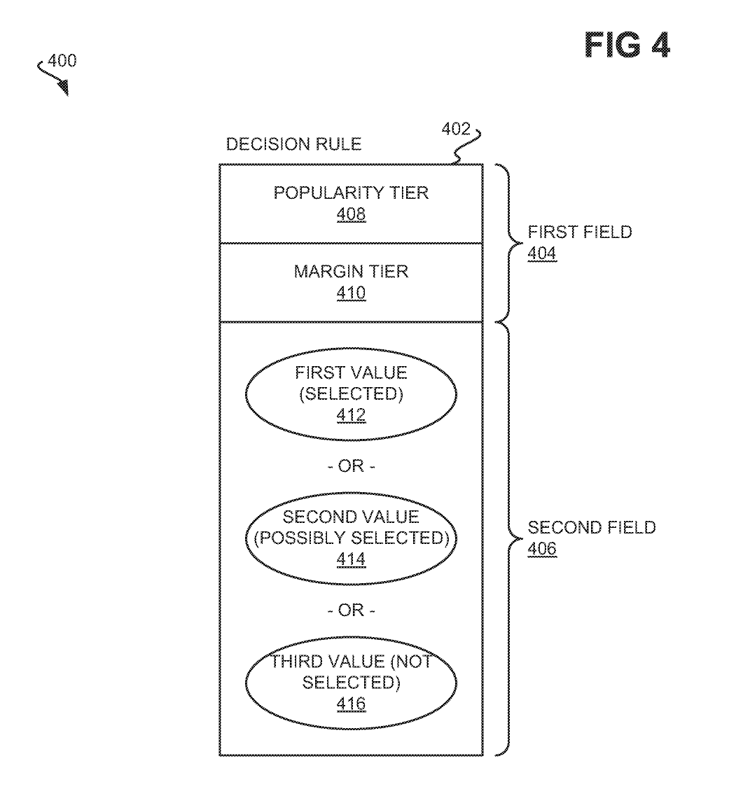

FIG. 4 shows a representative decision rule 402, according to an embodiment of the disclosure. The decision rule 402 includes a first field 404 and a second field 406. The first field 404 indicates the popularity tier 408 to which the decision rule 402 applies, and the margin tier 410 to which the decision rule 402 applies. That is, a given product is said to be subjected to the decision rule 402 where the given product has been assigned to both the popularity tier 408 and the margin tier 410 of the rule 402.

The second field 406 indicates whether the products to which the decision rule 402 applies by virtue of the first field 404 are to be selected for offering for sale to the consumers by the retailer. In one embodiment, the second field 406 can take on one of at least three different values. The first value 412 indicates that the products to which the decision rule 402 applies are definitely to be selected for offering for sale to consumers. The second value 414 indicates that the products to which the decision rule 402 applies may be selected (i.e., possibly or potentially selected) for offering for sale to consumers. The third value 416 indicates that the products to which the decision rule 402 applies are to definitely not be selected for offering for sale to consumers.

There can be more than three different values. For example, rather than just one second value 414, there may be a number of such second values 414, which are ordered. For example, a highest second value 414 may indicate that the products subjected to such a decision rule 402 are to be selected before the products subjected to another such decision rule 402 that has a lower second value 414. In this way, finer granularity can be achieved between the first value 412, which mandates that products definitely be selected, and the third value 416, which mandates that products definitely not be selected.

Different decision rules 402 may have the same first value 412, second value 414, or third value 416 for the second field 406. However, for a given combination of a particular popularity tier 402 and a particular margin 410, there can be just one decision rule 402 that has such a first field 404. For example, for the combination of the most popular tier and the highest margin tier, there is just one decision rule 402. Likewise, for the combination of the most popular tier and the lowest margin tier, there is also just one decision rule 402, and so on.

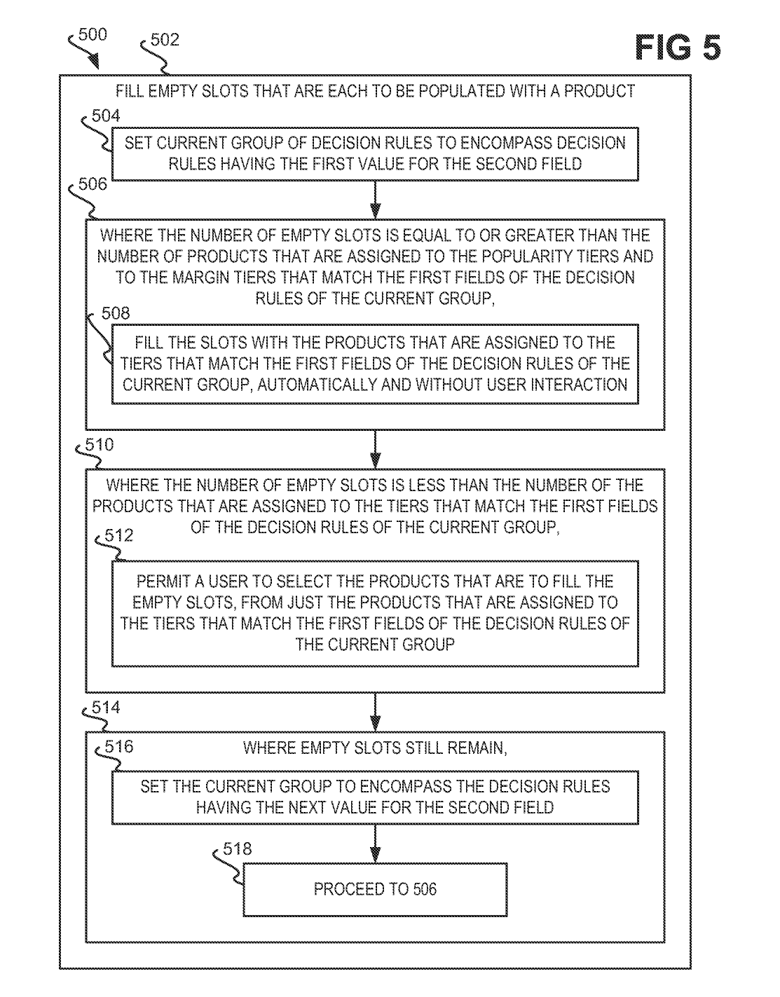

FIG. 5 shows a method 500 for selecting products for a retailer to offer for sale to consumers, according to an embodiment of the disclosure. The method 500 can be used to implement part 106 of the method 100 of FIG. 1. The method 500 thus fills empty product slots that are to each be populated with a product (502). There are a limited number of such product slots, as has been described above.

A current group of decision rules 402 is set to encompass the decision rules 402 that have the first value 412 for the second field 406 (504). That is, the set of decision rules 402 that have the first value 412 for the second filed 406 is set as the current group, where there may be one or more of such decision rules 402. These are the decision rules 402 indicating that the products present in the respective popularity tiers 408 and margin tiers 410 of their first fields 404 are to be selected for offering for sale.

The number of empty slots may be equal to or greater than the number of products that are assigned to both the popularity tier 408 and the margin tier 410 of the first field 404 of any decision rule 402 within the current group (506). For example, one decision rule 402 within the current group may specify the most popular tier and the highest margin tier within its first field 404, whereas another decision rule within the current group may specify the most popular tier and the middle margin tier within its first field 404. Where the number of empty slots is equal to or greater than the number of products that match the first field 404 of any of these decision rules, then the following is performed.

Specifically, the slots are filled with the products that match the first field 404 of any decision rule 402 within the current group (506), automatically and without user interaction. For example, there may be twenty empty slots. There may further be five products that are assigned to both the popularity tier 408 and the margin tier 410 of the first field 404 of the first decision rule of the previous paragraph, and eight products that are assigned to both the popularity tier 408 and the margin tier 410 of the first field 404 of the second decision rule of the previous paragraph. As such, thirteen products are assigned to thirteen of the twenty empty slots.

The number of empty slots may alternatively be less than the number of products that are assigned to both the popularity tier 408 and the margin tier 410 of the first field 404 of any decision rule 402 within the current group (510). For example, one decision rule 402 within the current group may specify the middle popularity tier and the middle margin tier within its first field 404, whereas another decision rule within the current group may specify the middle popularity tier and the highest margin tier within its first field 404. Where the number of empty slots is less than the number of products that match the first field 404 of any of these decision rules, then the following is performed.

Specifically, the user is permitted to select the products that are to fill the empty slots, from just the products that match the first field 404 of any decision rule 402 within the current group (506). For example, there may be seven remaining empty slots. There may be six products that are assigned to both the popularity tier 408 and the margin tier 410 of the first field 404 of the first decision rule of the previous paragraph, and three products that are assigned to both the popularity tier 408 and the margin tier 410 of the first field 404 of the second decision rule of the previous paragraph. As such, there are nine products, but just seven empty slots.

Therefore, the user is permitted to select which of the nine products should fill the seven empty slots. In this respect, the user does not experience information overload. For example, if there are over one-hundred total products, the user does not have to review all one-hundred products to select the products that should fill the remaining seven empty slots. Rather, nine of the products are in effect preselected for the user, and the user then just has to decide which of these nine products should fill the remaining seven empty slots. Indeed, in one embodiment, the overall method 100 of FIG. 1 may itself be performed iteratively to decreasing subsets of empty slots, to reduce information overload even further. It is noted, therefore, that the user thus uses the popularity, tiers and the margin tiers to influence which of the products are selected to fill the empty slots.

After performing part 506 or part 510, if empty slots still remain (514), then the method 500 sets the current group to encompass the decision rules 402 having the next value for the second field 406 (516), and the method 500 proceeds back to part 506 (518). For example, if the current group encompasses the decision rules 402 having the first value 412 for the second field 406, the current group is set in part 516 to instead encompass the decision rules 402 having the second value 414 for the second field 406. Likewise, if the current group encompasses the decision rules 402 having the second value 414 for the second field 406, the current group is set in part 516 to instead encompass the decision rules 402 having the third value 416 for the second field 406.

In the embodiment where there is more than one second value 414, the next value for the second field 406 from the first value 412 is the highest second value 414. The second values 414 are then proceeded through in order if needed. If the lowest second value 414 is reached, the next value for the second field 406 is the third value 416.

The method 500 can effectively rank the products that are selected for the retailer to offer for sale. For example, the products that are assigned to both the highest popularity tier and the highest margin tier may be considered as being of higher rank than other products that are selected. As such, these products may receive higher visibility than the other products. For instance, the products may receive higher visibility in that they are displayed more prominently on an Internet web page, are given more space on the web page, and so on.

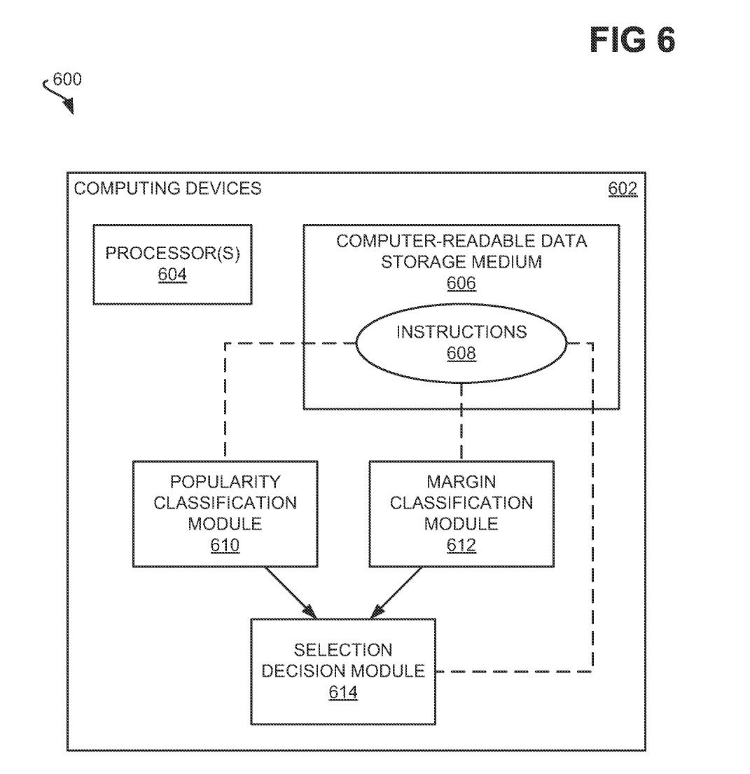

In conclusion, FIG. 6 shows a representative system 600, according to an embodiment of the disclosure. The system 600 includes one or more computing devices 602, such as desktop computers, laptop computers, server computing devices, client computing devices, and/or other types of computing devices. The computing devices 602 include one or more processors 604, and a computer-readable data storage medium 606, such as a hard disk drive, volatile or non-volatile semiconductor memory, and so on. The computer-readable data storage medium 606 stores instructions 608 that are executed by the processors 604. For instance, execution of the instructions 608 by the processors 604 can cause any of the above-described methods being performed.

The instructions 608 specifically implement a popularity classification module 610, a margin classification module 612, and a selection decision module 614. The popularity classification module 610 assigns each product to a popularity tier, as has been described in relation to part 102 of the method 100 of FIG. 1 and in relation to the method 200 of FIGS. 2A and 2B. As such, the popularity classification module 610 receives as input data representative of the products, the percentile ranges that define the popularity tiers, sources of preexisting data and in one embodiment their associated weights, and how long ago the products have been released, among other types of data. In turn, the popularity classification module 610 generates as output data indicating to which popularity tier each product has been assigned.

The margin classification module 612 assigns each product to a margin tier, as has been described in relation to part 104 of the method 100 of FIG. 1 and in relation to the method 300 of FIG. 3. As such, the margin classification module 612 receives as input data representative of the products, the percentile ranges that define the margin tiers, and the actual margins of the products, among other types of data. In turn, the margin classification module 612 generates as output data indicating to which margin tier each product has been assigned.

Finally, the selection decision module 614 selects which of the products to offer for sale by the retailer to consumers by applying decision rules to the products as have been assigned to the popularity tiers and to the margin tiers, as has been described in relation to part 106 of the method 100 of FIG. 1 and in relation to the method 500 of FIG. 5. As such, the selection decision module 614 receives as input data representative of the products, the output from the popularity classification module 610 and from the margin classification module 612, and the decision rules, such as has been described above in relation to FIG. 4, among other types of data. In turn, the selection decision module 614 generates as output data indicating which products have been selected to offer for sale to consumers by the retailer.

We claim:

1. A method comprising:
assigning, by a computing device, each product of a plurality of products to one of a plurality of popularity tiers, the popularity tiers ordered from a most popular tier to a least popular tier, the popularity tiers indicating how popular the products are expected to be among consumers;
assigning, by the computing device, each product to one of a plurality of margin tiers, the margin tiers ordered from a highest margin tier to a lowest margin tier, the margin tiers indicating how much money a retailer makes in selling the products to the consumers; and,
selecting, by the computing device, which of the products to offer for sale by the retailer to the consumers by applying a plurality of decision rules to the products as have been assigned to the popularity tiers and to the margin tiers.

2. The method of claim 1, wherein selecting which of the products to offer for sale by the retailer to the consumers further ranks the products that are offered for sale by the retailer to the consumers.

3. The method of claim 1, wherein at least one of the products is a bundle made up of two or more products.

4. The method of claim 1, wherein each decision rule comprises:
a first field indicating a given popularity tier of the popularity tiers and a given margin tier of the margin tiers to which the decision rule pertains; and,
a second field indicating whether the products that are present in both the given popularity tier and the given margin tier are to be selected for offering for sale to the consumers.

5. The method of claim 4, wherein the second field comprises a value selected from:
a first value indicating that the products that are present in both the given popularity tier and the given margin tier are to be selected for offering for sale to the consumers;
one or more second values indicating that the products that are present in both the given popularity tier and the given margin may be selected for offering for sale to the consumers; and,
a third value indicating that the products that are present in both the given popularity tier and the given margin tier are not to be selected for offering for sale to the consumers.

6. The method of claim 5, wherein selecting which of the products to offer for sale to the consumers by applying the decision rules to the products as have been assigned to the popularity tiers and to the margin tiers comprises filling a plurality of slots that are each to be populated with one of the products, where each slot is an empty slot before the one of the products has been assigned to the slot and each slot is a filled slot after the one of the products has been assigned to the slot.

7. The method of claim 6, wherein filling the slots comprises:
setting a current group of the decision rules to encompass the decision rules having the first value for the second field;
as an entry point of the method, where a number of empty slots is equal to or greater than a number of the products that are assigned to the popularity tiers and to the margin tiers that match the first fields of the decision rules of the current group, performing in order:
filling the slots with the products that are assigned to the popularity tiers and to the margin tiers that match the first fields of the decision rules of the current group, automatically and without user interaction;
where empty, slots still remain, setting the current group of the decision rules to encompass the decision rules having a next value for the second field, where the second value is the next value for the first value, and the third value is the next value for the second value, and proceeding back to the entry point.

8. The method of claim 7, wherein filling the slots further comprises:
where the number of empty slots is less than the number of the products that are assigned to the popularity tiers and to the margin tiers that match the first fields of the decision rules of the current group,
permitting a user to select the products that are to fill the empty slots, from just the products that are assigned to the popularity tiers and to the margin tiers that match the first fields of the decision rules of the current group.

9. The method of claim 8, wherein the user is to use the popularity tiers and the margin tiers to influence which of the products are selected to fill the empty slots.

10. The method of claim 1, wherein assigning each product to one of the popularity tiers comprises, for the product:
for each source of one or more sources of preexisting sales data,
where the product is present within the source of preexisting sales data, determining a popularity score of the product within the source of preexisting sales data based at least on a rank of the product within the source of preexisting sales data;
where the product is absent from the source of preexisting sales data, determining the popularity score of the product within the source of preexisting sales data based on ranks of one or more similar products within the source of preexisting sales data.

11. The method of claim 10, wherein assigning each product to one of the popularity tiers further comprises, for the product:
for each source of one or more sources of preexisting sales data,
adjusting the popularity score of the product within the source of preexisting sales data based on one or more factors.

12. The method of claim 10, wherein assigning each product to one of the popularity tiers further comprises, for the product:
determining another popularity score of the given product based on how long ago the given product was released for purchase by the consumers;
permitting a user to specify weights to the popularity scores;
determining an overall popularity score for each product as a sum of each popularity score times the weight of the popularity score;
permitting a user to associate each popularity tier with a percentile range of the overall popularity scores for the products; and,
assigning each product to the popularity tier having the percentile range encompassing the overall popularity score for the product.

13. The method of claim 1, wherein assigning each product to one of the margin tiers comprises:
permitting a user to associate each margin tier with a percentile range of margins for the products; and,
assigning each product to the margin tier having the percentile range encompassing the margin for the product.

14. A computer-readable data storage medium having one or more computer programs stored thereon that when executed by a computing device causes a method to be performed, the method comprising:
assigning, by a computing device, each product of a plurality of products to one of a plurality of popularity tiers, the popularity tiers ordered from a most popular tier to a least popular tier, the popularity tiers indicating how popular the products are expected to be among consumers;
assigning, by the computing device, each product to one of a plurality of margin tiers, the margin tiers ordered from a highest margin tier to a lowest margin tier, the margin tiers indicating how much money a retailer makes in selling the products to the consumers; and,
selecting, by the computing device, which of the products to offer for sale by the retailer to the consumers by applying a plurality of decision rules to the products as have been assigned to the popularity tiers and to the margin tiers.

15. A system comprising:
a processor;
a computer-readable data storage medium to store a plurality of instructions executable by the processor;
a popularity classification module implemented by the instructions to assign each product of a plurality of products to one of a plurality of popularity tiers, the popularity tiers ordered from a most popular tier to a least popular tier, the popularity tiers indicating how popular the products are expected to be among consumers;
a margin classification module implemented by the instructions to assign each product to one of a plurality of margin tiers, the margin tiers ordered from a highest margin tier to a lowest margin tier, the margin tiers indicating how much money a retailer makes in selling the products to the consumers; and,
a selection decision module implemented by the instructions to select which of the products to offer for sale by the retailer to the consumers by applying a plurality of decision rules to the products as have been assigned to the popularity tiers and to the margin tiers.
